(19) United States
(12) Patent Application Publication
(10) Pub. No.: US 2003/0078081 A1
(43) Pub. Date: Apr. 24, 2003

(54) Call announcement system and method

(76) Inventor: Kenneth J. Schmier, Emeryville, CA (US)

Correspondence Address: LAW OFFICES OF PHILIP DALTON, 236 WEST PORTAL AVE., NO. 15, SAN FRANCISCO, CA, 94127-1423, US

(21) Appl. No.: 10/040,616

(22) Filed: Oct. 19, 2001

(51) Int. Cl. H04M 1/00

(52) U.S. Cl. 455/567; 455/550

(57) ABSTRACT

A telephone system is disclosed which includes a voice announcement system for announcing incoming calls.

### A. BACKGROUND OF THE INVENTION

1. Field of the Invention

The present invention relates to communications devices and systems, to telephones in general and, in particular, to wireless communications devices including wireless telephones and cellular telephones.

2. Description of the Related Art

Wireless devices such as so-called cellular (cell) telephones permit use and communication over wide areas, especially in metropolitan and outlying regions, restricted only by the broadcast and receiving capability of the associated system.

Historically telephones have “rung”. The ringing is the mechanical signaling intended to alert anyone present in a particular room or space that the telephone is receiving a call. Because the telephone in that space was typically owned by persons associated with the space, little confusion was generated by the ringing of the phone since the possible recipients of a call were easily known. As alluded to here, the advent of wireless and cell telephones has brought the situation in which large numbers of telephones may be in one room or space. Ringing of any one of those phones may cause a large number of persons to scramble to retrieve their own telephone units, believing a certain “ring” may be for them. Such devices already allow multiple “ring” tones or patterns, but such patterns are not sufficiently unique to avoid causing all present to take notice. Further, in certain places like a restaurant, a symphony or a library, a ring tone will seem to all present to be grossly out of place.

### B. BRIEF SUMMARY OF THE INVENTION

In one embodiment, a telephone in accordance with the present invention includes a message or voice announcement system or unit adapted for broadcasting a selected message announcing a call, and a control circuit for activating the announcement unit in response to a call received by the telephone, to broadcast the message.

In another aspect, the present invention is embodied in a telephone of the type including a control circuit adapted for detecting an incoming call, which telephone comprises: an announcement unit comprising broadcast means adapted for broadcasting a message indicative of an incoming call, and message storage means electronically connected to the broadcast means for broadcasting a voice message via the broadcast means; and a control circuit adapted for activating the announcement unit in response to an incoming call, for broadcasting a voice message via the broadcast means.

In another embodiment, a method according to the present invention relates to storing and announcing an incoming telephone call, comprising the steps of: storing a message in a selected telephone announcing incoming calls; and, upon receipt of an incoming telephone call by the selected telephone, broadcasting the message via a speaker associated with the selected telephone, thereby announcing the telephone call.

In another embodiment, a method according to the present invention relates to storing and transmitting via a telephone network a message announcing an incoming telephone call, and comprises the steps of: storing, in the telephone network, a message announcing an incoming call directed to a first telephone; upon input of a call from a second telephone into the telephone network directed to the first telephone, electronically transmitting said message to the first telephone; at the first telephone, broadcasting said message via a speaker associated with the selected telephone; and completing the connection between the second telephone and the first telephone.

In yet another embodiment, a method according to the present invention relates to transmitting via a telephone network a message announcing an incoming call and comprises the steps of: electronically transmitting to a first telephone a voice message input to the telephone network via a second telephone; broadcasting said message via a speaker associated with the first telephone; and completing the connection between the second telephone and the first telephone.

Other embodiments of the present invention are described in the specification, drawings and claims.

It is one the benefits of the present invention that in one embodiment a voice announcement is substituted for a ring tone, allowing a person or persons to use natural abilities to recognize both words and voice qualities to instantly recognize phone alerts that relate to that person or persons, and to ignore all others. The voice announcement unit or system according to the present invention eliminates one of the most irritating aspects of cell phone usage, that is, the ringing of such phones to notify the user of an incoming or saved call. As mentioned, in certain places a ring tone will seem to all present to be out of place, while a subtle voice whisper would not.

### C. BRIEF DESCRIPTION OF THE DRAWING

The above and other aspects of the present invention are described below in conjunction with the drawing, in which:

FIG. 1 is a block diagram depicting components of a telephone, constructed in accordance with the present invention, which includes a voice announcement unit.

### D. DETAILED DESCRIPTION OF THE INVENTION

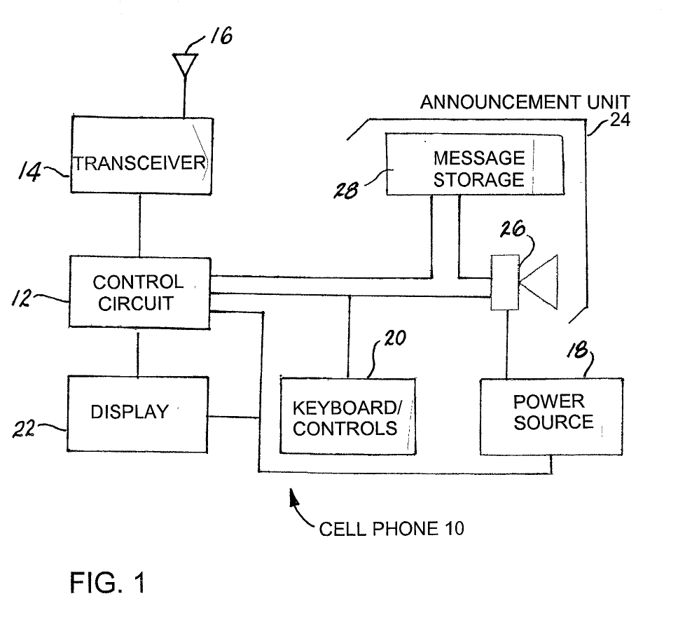

Turning now to the drawing, FIG. 1 depicts components of a preferred embodiment 10 of a communications device in accordance with the present invention. The device can be any of many different types of communications devices, including telephones in general and portable communications devices, including wireless telephones and, especially, cell telephones. Please note, wireless and cell telephones and their components in general are well known. It is thus unnecessary to describe such systems in great detail. Components which are not relevant to the voice announcement unit may be omitted here. For convenience, but not by way of limitation, the communications device 10 is called a “device,” or a “cell phone,” which is the presently preferred embodiment.

The components include control circuit 12 and RF transceiver 14 and antenna 16 for receiving/broadcasting information from/to remote stations. Power source 18 comprises one or more (typically rechargeable) batteries. Keyboard and control unit 20 inputs commands and information to the phone in a well known manner and a display 22 displays information regarding the status of the system, such as incoming calls, and information as it is being input by the keyboard.

The communications device 10 includes a message or voice announcement system or unit 24 (hereafter also referred to as an “announcement unit”) which comprises broadcast means for broadcasting sound in the vicinity of the phone 10; and message storage means which is adapted for storing voice messages or other sound messages and is electronically connected to the broadcast means for broadcasting the message via the broadcast means.

The announcement unit 24 is included in the device 10 in addition to or instead of standard ringer and buzzer units and is used for announcing new incoming calls, for announcing previous calls stored in system voice mail, etc.

Broadcast means 26 may comprise a speaker 26, which can be the speaker in the telephone headset but preferably is the speaker in the speakerphone system or another separate speaker positioned to provide sufficient range, that is, so that messages can be heard at a distance from the phone.

Message storage means 28 may comprise one or more of several sound/voice message message systems, including a tape player containing selectable prerecorded messages stored on the tape; a digital sound recorder and microphone or a tape sound recorder and microphone, for recording one or preferably a variety of selectable messages into the cell phone; and/or a voice synthesizer unit including a microphone for storing at a disk or microchip memory, a message or a number of selectable messages.

In operation, when an incoming call is received by the phone 10 via antenna 16 and transceiver 14, the control circuit 12 detects the incoming call and activates the voice announcement unit 24, which broadcasts a preselected, prerecorded message at a volume which has been established in conventional fashion using the keyboard 20 and the control unit, or automatically set by sensing ambient noise and calculating an appropriate level of volume necessary to attract attention without being unduly disruptive. Examples of such announcement messages are “Billie, you have a call;” “Bill;” “Telephone call;” “Incoming call;” “Message;” etc. In addition an announcement such as “Message” can be recorded in Billie's voice or Billie's child's voice, that is, in a voice Billie is likely to notice as related to her/him, but which is unlikely to attract the attention of anyone else. Obviously, these are only a few of the many announcements which are readily made available.

Alternatively, the voice announcement unit 24 can also deliver a message placed into its memory by a caller, who speaks the announcement into a telephone when calling the number associated with the selected phone 10, through a certain protocol such as speaking after a certain tone alert and before another ending tone alert, or by accessing the feature with certain DTMF codes, and that message given then will be the message used to alert the recipient of the phone call. Such a message can instead be stored in a telephone network and transmitted to the selected phone 10 and its voice announcement unit 24 by a telephone company ahead of the answering of the recipient's telephone call in the same manner that Caller ID data is put into a display on a telephone call receiver's equipped phone.

In summary, but not exhaustively, several of the ways in which the present invention can be implemented, based upon the configuration of the telephone 10 and an associated telephone network, include (1) storing an announcement message in the anouncement unit of a selected telephone using the selected telephone itself or a remote telephone or other device to input the announcement message, and activating the stored message to announce an incoming call; (2) transmitting to the announcement unit of a selected telephone an announcement message from a caller using a telephone remote to the selected telephone, for announcing that caller's call; and (3) storing an announcement message in a telephone network and transmitting the stored message to the announcement unit of a selected telephone for announcing an incoming call.

In short, according to the present invention a call to a communications device such as a cell phone is announced to the possessor of the device by a voice, not by ringing. A voice tends to be less intrusive, is readily identifiable by specific persons, and does not attract the attention of others as does a “ring” of any pattern. Rather, for other persons in the vicinity of the cell phone in a public place such as a restaurant, the voice announcer tends to blend into the background of voices and conversations.

The present invention has been described in terms of preferred and other embodiments. The invention, however, is not limited to the embodiments described and depicted here. One familiar with the art to which the present invention pertains will appreciate from the embodiments disclosed here, that the present invention is applicable in general to communications devices and will readily adapt the devices, systems and methods described here to other embodiments. The invention is defined by the claims appended hereto

What is claimed is:

1. A telephone of the type including a control circuit adapted for detecting an incoming call; the telephone further comprising: an announcement unit for broadcasting a voice message indicative of an incoming call; and wherein the control circuit is adapted for activating the announcement unit in response to detecting an incoming call.

2. The telephone of claim 1 wherein the telephone is a wireless telephone.

3. The telephone of claim 1 wherein the telephone is a cellular telephone.

4. The telephone of claim 1 wherein the announcement unit comprises a sound recorder and a microphone for recording messages.

5. The telephone of claim 1 wherein the announcement unit comprises a sound player containing at least one prerecorded message.

6. The telephone of claim 1 wherein the announcement unit comprises a digital sound recorder and a microphone for recording messages.

7. The telephone of claim 1 wherein the announcement unit comprises a voice synthesizer unit and memory containing at least one stored message.

8. A telephone system of the type including a control circuit adapted for detecting an incoming call; the telephone further comprising:
an announcement unit comprising broadcast means adapted for broadcasting a message indicative of an incoming call, and message storage means electronically connected to the broadcast means for broadcasting a voice message via the broadcast means; and
a control circuit adapted for activating the announcement unit in response to an incoming call, to broadcast a voice message via the broadcast means.

9. A method for storing an announcement of, and announcing an incoming telephone call, comprising:
in a selected telephone, storing a message announcing incoming calls;
upon receipt of an incoming telephone call by the selected telephone, broadcasting the message via a speaker associated with the selected telephone, thereby announcing the telephone call.

10. A method for storing and transmitting via a telephone network a message announcing an incoming telephone call, comprising:
in a telephone network, storing a message announcing an incoming call directed to a first telephone;
upon input of a call from a second telephone into the telephone network directed to the first telephone, electronically transmitting said message to the first telephone;
at the first telephone, broadcasting said message via a speaker associated with the selected telephone; and
completing the connection between the second telephone and the first telephone.

11. A method for transmitting via a telephone network a message announcing an incoming call, comprising:
in a telephone network, electronically transmitting to a first telephone a voice message input at a second telephone;
broadcasting said message via a speaker associated with the first telephone; and
completing the connection between the second telephone and the first telephone.
